(19) United States
(12) Patent Application Publication
(10) Pub. No.: US 2025/0365173 A1
(43) Pub. Date: Nov. 27, 2025

(54) FACILITATING PARTICIPATION IN A VIRTUAL MEETING OF AN ABSENT INVITED VIRTUAL MEETING USER

(71) Applicant: Google LLC, Mountain View, CA (US)

(72) Inventors: Anton Volkov, Seattle, WA (US); Jennifer Iting Shen, Palo Alto, CA (US); David Alan Sleeper Citron, Kirkland, WA (US); Felix David Mejia Abreu, Orlando, FL (US); Justin Volz, Oakland, CA (US)

(21) Appl. No.: 18/673,787

(22) Filed: May 24, 2024

(51) Int. Cl. H04L 12/18

(52) U.S. Cl. CPC H04L 12/1831

(57) ABSTRACT

A method for participation, in a virtual meeting, of an absent invited virtual meeting user includes receiving input of a first user that has been invited to participate in the virtual meeting. The input of the first user indicates an inability to attend the virtual meeting and provides first data to be discussed during the virtual meeting. The method includes causing a virtual meeting UI to be presented during the virtual meeting between multiple participants. The UI includes a UI element associated with the first data provided by the first user that is not present during the virtual meeting. The method includes generating a summary of the virtual meeting. The summary covers presentation of at least a portion of the first data during the virtual meeting. The method includes causing the summary to be accessible by a client device of the first user.

### TECHNICAL FIELD

Aspects and implementations of the present disclosure relate to virtual meetings and more specifically to facilitating the participation, in a virtual meeting, of an absent invited virtual meeting user.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for participation, in a virtual meeting, of an absent invited virtual meeting user. The method includes receiving input of a first user that has been invited to participate in a virtual meeting. The input of the first user indicates an inability to attend the virtual meeting and provides first data to be discussed during the virtual meeting. The method includes causing a virtual meeting user interface (UI) to be presented during the virtual meeting between multiple participants. The virtual meeting UI includes a UI element associated with the first data provided by the first user that is not present during the virtual meeting. The method includes generating a summary of the virtual meeting. The summary covers presentation of at least a portion of the first data during the virtual meeting. The method includes causing the summary to be accessible by a client device of the first user associated with the virtual meeting.

Another aspect of the disclosure provides a system for participation, in a virtual meeting, of an absent invited virtual meeting user. The system includes a memory and a processing device coupled to the memory. The processing device is configured to perform operations. The operations include receiving input of a first user that has been invited to participate in a virtual meeting. The input of the first user indicates an inability to attend the virtual meeting and provides first data to be discussed during the virtual meeting. The operations include causing a virtual meeting UI to be presented during the virtual meeting between multiple participants. The virtual meeting UI includes a UI element associated with the first data provided by the first user that is not present during the virtual meeting. The operations include generating a summary of the virtual meeting. The summary covers presentation of at least a portion of the first data during the virtual meeting. The operations include causing the summary to be accessible by a client device of the first user associated with the virtual meeting.

Another aspect of the disclosure provides a non-transitory computer-readable storage medium comprising instructions that, when executed by a processing device, cause the processing device to perform operations. The operations include receiving input of a first user that has been invited to participate in a virtual meeting. The input of the first user indicates an inability to attend the virtual meeting and provides first data to be discussed during the virtual meeting. The operations include causing a virtual meeting UI to be presented during the virtual meeting between multiple participants. The virtual meeting UI includes a UI element associated with the first data provided by the first user that is not present during the virtual meeting. The operations include generating a summary of the virtual meeting. The summary covers presentation of at least a portion of the first data during the virtual meeting. The operations include causing the summary to be accessible by a client device of the first user associated with the virtual meeting.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for facilitating the participation, in a virtual meeting, of an absent invited virtual meeting user, in accordance with some implementations of the present disclosure.

FIG. 2 illustrates a flow diagram of a method for facilitating the participation, in a virtual meeting, of an absent invited virtual meeting user, in accordance with some implementations of the present disclosure.

FIG. 3A illustrates a schematic block diagram for an artificial intelligence (AI) training subsystem of a virtual meeting platform, in accordance with some implementations of the present disclosure.

FIG. 3B illustrates a schematic block diagram for an AI inference subsystem of a virtual meeting platform, in accordance with some implementations of the present disclosure.

FIG. 4 illustrates an example user interface for a calendar software application, in accordance with some implementations of the present disclosure.

FIG. 5 illustrates an example user interface for a virtual meeting, in accordance with some implementations of the present disclosure.

FIG. 6 illustrates an example user interface for a calendar software application, in accordance with some implementations of the present disclosure.

FIG. 7 illustrates a block diagram depicting an example computer system, in accordance with some implementations of the present disclosure.

### DETAILED DESCRIPTION

Aspects of the present disclosure relate to facilitating the participation, in a virtual meeting, of an absent invited virtual meeting user. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

Some users may not be able to attend a virtual meeting or may not be able to attend the entirety of a virtual meeting, for example, because the user may have multiple meetings scheduled at the same time, or a previous meeting may last longer than scheduled and may overlap with a current meeting. In a typical virtual meeting, if a user is not present during the virtual meeting or not present for a portion of the meeting, the user cannot participate in the virtual meeting or in the missed portion and cannot provide input on the points being discussed. This presents several disadvantages. For example, the user that is invited to the virtual meeting but is unable to attend cannot provide input to the points discussed during the virtual meeting, resulting in the meeting being less efficient and effective. Additionally, a participant present at the virtual meeting may need to take notes for the absent user, which may be distracting for the note-taking participant and may not allow the note-taking participant to fully participate in the meeting. Furthermore, the note-taking user may miss some discussion points or misinterpret the items being discussed. The note-taking user may then need to send the notes to the absent user (e.g., through email) or may need to have another virtual meeting with the absent user to provide the information the absent user missed, which can use computing system resources. Additionally, participating in a large number of virtual meetings can be exhausting for users.

Implementations of the present disclosure address the above and other deficiencies by providing systems and methods that facilitate the participation, in a virtual meeting, of an absent invited virtual meeting user. A user that is unable to attend a virtual meeting may send data to a server of a virtual meeting system. The data can include discussion points for the virtual meeting. During the virtual meeting, a virtual meeting user interface (UI) can be presented on the virtual meeting's participants' client devices, and the virtual meeting UI can include a UI element associated with the data from the absent user (e.g., a side bar that lists the discussion points provided by the absent user). An AI model can generate a summary of the virtual meeting that covers, among other things, discussion during the virtual meeting of the absent user's discussion points. A virtual meeting server can make the summary accessible to the absent user.

Aspects of the present disclosure provide technical advantages over previous solutions. Aspects of the present disclosure can allow a user that is not present during a virtual meeting to provide discussion points or other materials for use during the virtual meeting. Aspects of the present disclosure provide access to one or more AI-generated summaries of the discussion of the provided discussion points and other materials, which increases the efficiency of the virtual meeting and improves virtual meeting experience for the absent user. Additionally, aspects of the present disclosure reduce the need for a note-taking virtual meeting participant to follow up with the absent user, which reduces the use of computing system resources (e.g., by reducing emails sent from the note-taking participant to the absent user and reducing additional virtual meetings between the note-taking user and the absent user).

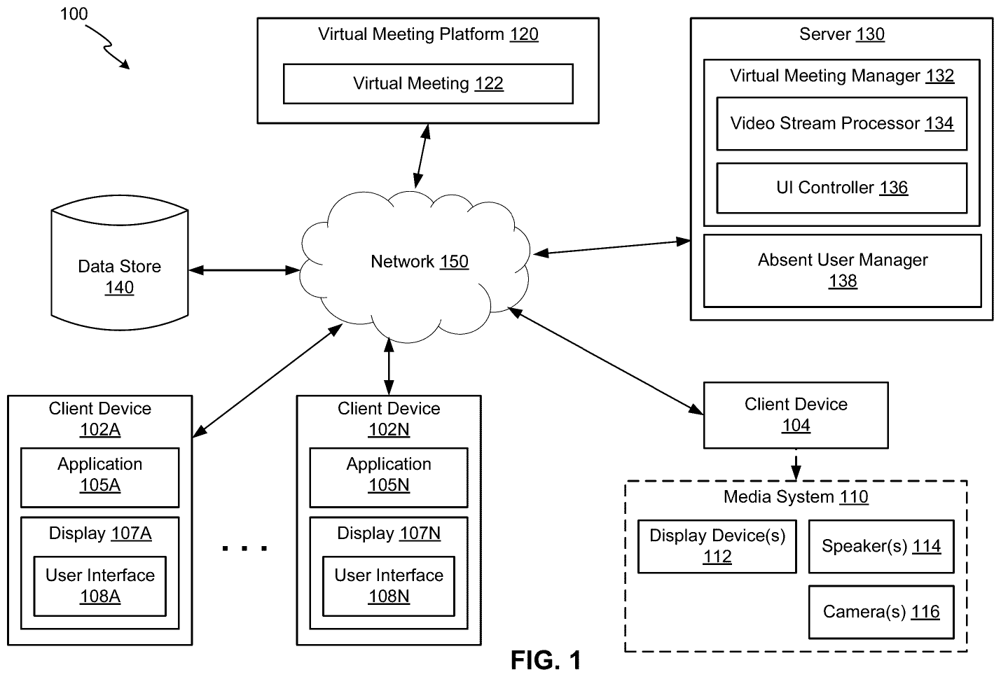

FIG. 1 illustrates an example system architecture 100, in accordance with implementations of the present disclosure. The system architecture 100 includes one or more client devices 102A-N or 104, a virtual meeting platform 120, a server 130, and a data store 140, each connected to a network 150.

In some implementations, the virtual meeting platform 120 enables users of one or more of the client devices 102A-N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can provide the UIs 108A-N to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-107N by the client applications 105A-N executing on the operating systems of the client devices 102A-N, 104. In some implementations, the virtual meeting manager 132 determines visual items for presentation in the UIs 108A-N during a virtual meeting 122. A visual item can refer to a UI element that occupies a particular region in the UI 108A-N and is dedicated to presenting a video stream from a respective client device 102A-N, 104. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 may be configured to receive video streams from one or more of the client devices 102A-N, 104. The video stream processor 134 may be configured to determine visual items for presentation in the UI of such client devices 102A-N, 104 (e.g., the UIs 108-108N, discussed below) during the virtual meeting 122. Each visual item can correspond to a video stream from a client device 102A-N, 104 (e.g., the video stream pertaining to one or more participants of the virtual meeting 122). In some implementations, the virtual meeting 122 further includes, for each participant of the one or more participants, first audio data associated with an audio stream produced by a client device 102A-N, 104 of a respective participant. The video stream processor 134 can receive audio streams associated with the video streams from the client devices (e.g., from an audiovisual component of the client devices 102A-N, 104). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122. The UI can include multiple regions. Each region can display a video stream pertaining to one or more participants of the virtual meeting 122. The UI controller 136 can control which video stream is to be displayed by providing a command to one or more client devices 102A-N, 104 that indicates which video stream is to be displayed in which region of the UI (along with the received video and audio streams being provided to the client devices 102A-N, 104). For example, in response to being notified of the determined visual items for presentation in the UI 108A-N, the UI controller 136 can transmit a command causing each determined visual item to be displayed in a region of the UI and/or rearranged in the UI.

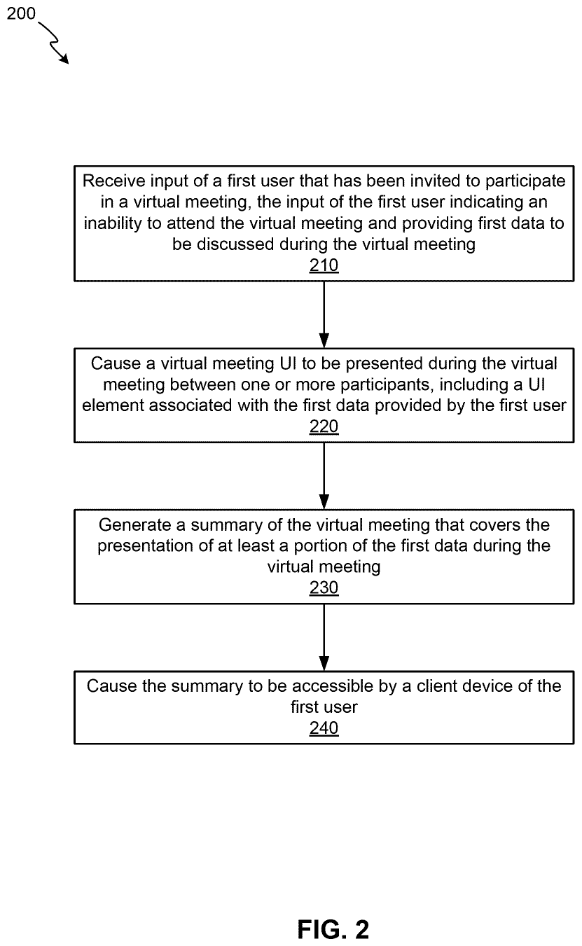

In one or more implementations, the virtual meeting manager 132 includes an absent user manager 138. The absent user manager 138 may include a software application (or a subset thereof) that performs certain virtual meeting functionality for the virtual meeting manager 132. The absent user manager 138 may be configured to present data associated with a user that is absent from the virtual meeting 122, generate one or more summaries based on the virtual meeting 122, or other virtual meeting functionality, as discussed herein. The absent user manager 138 may include an AI inference subsystem. The AI inference subsystem may include one or more AI models configured to generate a transcript of the virtual meeting 122, generate one or more summaries of the virtual meeting 122, and perform other functionality as discussed herein. The absent user manager 138 may use the AI inference subsystem to assist the absent user manager 138 in performing one or more operations. Functionality of the absent user manager 138 is discussed further below in relation to FIG. 2.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. The display device 112 can be, for example, a smart display or a non-smart display (e.g., a display that is not itself configured to connect to the network 150). Users that are physically present in the room can use the media system 110 rather than their own devices (e.g., one or more of the client devices 102A-N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to the one or more client devices 102A-N, the client device 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-N, 104 transmit the generated video stream to the virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-N, 104 transmit the generated audio data to the virtual meeting manager 132.

In some implementations, each client device 102A-N or 104 includes a respective client application 105A-N, which can be a mobile application, a desktop application, a web browser, etc. The client application 105A-N can present, on a display device 107A-N of a client device 102A-N or a UI (e.g., a UI of the UIs 108A-N), one or more features of the application 105A-N for users to access the virtual meeting platform 120. For example, a user of a first client device 102A can join and participate in the virtual meeting 122 via a UI 108A presented on the display device 107A by the application 105A. The user can present a document to participants of the virtual meeting 122 using the UI 108A. Each of the UIs 108A-N can include multiple regions to present visual items corresponding to video streams of the client devices 102A-N provided to the server 130 for the virtual meeting 122.

In one or more implementations, the virtual meeting manager 132 and/or the absent user manager 138 is part of a client device 102A-N, 104. For example, the application 105A-N can include the absent user manager 138, which can present data associated with an absent virtual meeting user, generate summaries based on the virtual meeting 122, and perform other functionality. In some implementations, the application 105A of a first client device 102A sends the video stream produced by the client device 102A to the other client devices 102B-N, 104 and receives the video streams from the other client devices 102B-N, 104, and the applications 105A-105N can generate their respective virtual meeting UIs 108A-108N or can finalize their respective UIs 108A-N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-N, 104 for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N, 104 and/or concurrently editable by the users. In some implementations, the data store stores data provided by a user that is absent from the virtual meeting 122 (e.g., discussion points), one or more summaries generated by the absent user manager 138, a transcript of the virtual meeting 122, or other data, as discussed herein.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 facilitating the participation, in a virtual meeting, of an absent invited virtual meeting user, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the absent user manager 138 performs one or more of the operations of the method 200.

At block 210, processing logic receives input of a first user that has been invited to participate in a virtual meeting 122. The input of the first user can indicate an inability to attend the virtual meeting 122 or a portion of the virtual meeting 122. The input of the first user can provide first data to be discussed during the virtual meeting 122. The virtual meeting manager 132 or the absent user manager 138 may receive the input of the first user.

In one implementation, the input of the first user includes a response to a calendar invite. The calendar invite may include a media type that allows a user to store and exchange calendaring and scheduling information for a calendar event. A calendar invite can be generated by a calendar software application. The calendar software application may be configured to access a calendar invite and display information based on the calendar invite (e.g., data that indicates a user that organized the corresponding calendar event, a start time, an end time, a location of the calendar event (which may include a physical location or may include data used to access a virtual meeting 122), etc.)). The calendar software application may include a software application that executes on a client device 102A-N, 104 or executes on a server or cloud platform and provides a UI to the client device 102A-N, 104 of a user.

In some implementations, responsive to a user using a calendar software application to access the calendar invite, the calendar software application generates a response to the calendar invite (sometimes referred to herein as a “calendar invite response”). The calendar invite response may include response data indicating whether the responding user plans on attending the calendar event corresponding to the calendar invite. The response data can indicate that the user who received the calendar invite plans on attending the virtual meeting, cannot attend the virtual meeting or a portion of the virtual meeting, or may be able to attend.

In one implementation, the response data indicates that the user who received the calendar invite cannot attend the virtual meeting or a portion of the virtual meeting but is providing first data, which includes one or more discussion points or materials to be discussed during the virtual meeting 122 in the user's absence. The first data may include textual content. Textual content may include text data (e.g., one or more text strings) or a reference to text data (e.g., a uniform resource locator (URL) that links to text data). The first data may include audio content. Audio content may include an audio file or a reference to audio data (e.g., an audio file stored on the Internet and is accessible using a URL). The first data may include video content. Video content may include a video file or a reference to video data.

In some implementations, the first user uses the calendar software application to input the first data. For example, the calendar software application's UI can provide a text box where the user can input textual content or a reference (e.g., URL) to textual, audio, or video content. The calendar software application's UI can provide a file selector where a user can select a file on the user's client device 102A-N, or the UI can provide a UI element that allows the user to drag and drop the file. The file may include the textual, video, or audio content.

At block 220, processing logic causes a virtual meeting UI 108A-N to be presented during the virtual meeting 122 between one or more participants. The virtual meeting UI 108A-N may include a UI element associated with the first data provided by the first user that is not present during the virtual meeting 122 or a portion of the virtual meeting 122. The virtual meeting UI 108A-N may include the UI element responsive to the absent user manager 138 providing the first data to the UI controller 136, which may provide the UI element to the UI 108A-N.

In one implementation, the UI element includes a side bar disposed on a side of the virtual meeting UI 108A-N. The side bar may include an area of the UI 108A-N on a left side, right side, top side, bottom side, or other area of the UI 108A-N that displays information. In some implementations, the UI element includes a notification presented in the virtual meeting UI 108A-N. The notification may include a pop-up dialog box in the UI 108A-N or some other notification element of the UI 108A-N. The UI 108A-N may present data based on the first data of the first user in some other manner.

The UI element may include data based on the first data provided by the user. For example, where the first data includes textual content, the UI element may include one or more strings of text, a URL, or content from the location referenced by the URL (e.g., a webpage or embedded content from a webpage). Where the first data includes audio content, the UI element may include a media player that allows a user to play the audio content. Where the first data includes video content, the UI element may include a media play that allows a user to watch the video content.

In some implementations, processing logic causes the presentation of the UI element associated with the first data in response to a predetermined amount of time elapsing since a beginning of the virtual meeting 122. This may allow participants of the virtual meeting 122 time to join the meeting and perform other initial tasks before beginning discussion of one or more topics of the virtual meeting 122. A configuration setting of the virtual meeting 122 may include the predetermined amount of time. The calendar invite response may include the predetermined amount of time (which may allow the user absent from the virtual meeting 122 to set the predetermined amount of time). In one implementation, processing logic causes the presentation of the UI element associated with the first data in response to the predetermined amount of time elapsing since a different virtual meeting 122 event (e.g., a predetermined number of virtual meeting 122 invitees joining the virtual meeting, a predetermined portion of the virtual meeting 122 invitees joining the virtual meeting 122, a host of the virtual meeting 122 interacting with a UI 108A-N element indicating the start of a discussion of topics for the virtual meeting 122, or some other event).

At block 230, processing logic generates a summary of the virtual meeting 122. In one implementation, the summary covers a presentation of at least a portion of the first data during the virtual meeting 122. The absent user manager 138 may generate the summary of the virtual meeting 122.

During the virtual meeting 122, the participants of the virtual meeting 122 can discuss multiple topics or discussion points. The first user that is absent from the virtual meeting 122 may desire to know what was discussed during the virtual meeting 122 about the first data, for example, one or more discussion points provided by the first user. Thus, the summary may cover discussion, during the virtual meeting 122, of the first data.

In one or more implementations, the virtual meeting manager 132 or some other component of the server 130 may generate a transcript of the virtual meeting 122. Generating the transcript of the virtual meeting 122 may include using a speech-to-text AI model. The speech-to-text AI model may receive, as input, audio data of the one or more audio streams corresponding to the different participants of the virtual meeting 122 and may generate a text representation of the audio data to generate a transcript of the virtual meeting 122. The virtual meeting manager 132 may store the transcript, e.g., on the server 130 or the data store 140. The speech-to-text AI model may generate the transcript in real time during the virtual meeting 122. The absent user manager 138 may have access to the transcript and may use the transcript of the virtual meeting 122 to generate the summary of the virtual meeting 122.

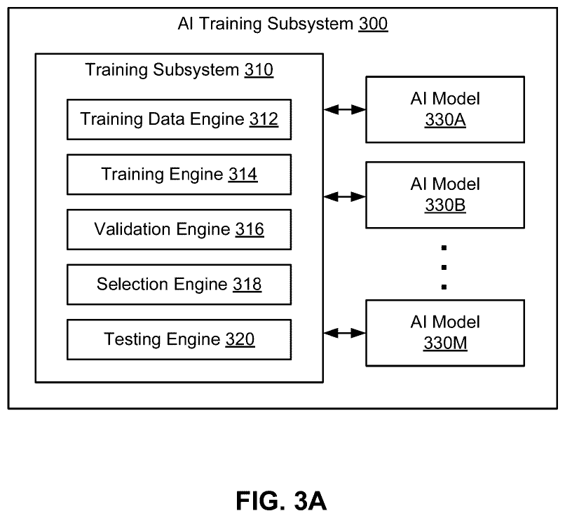

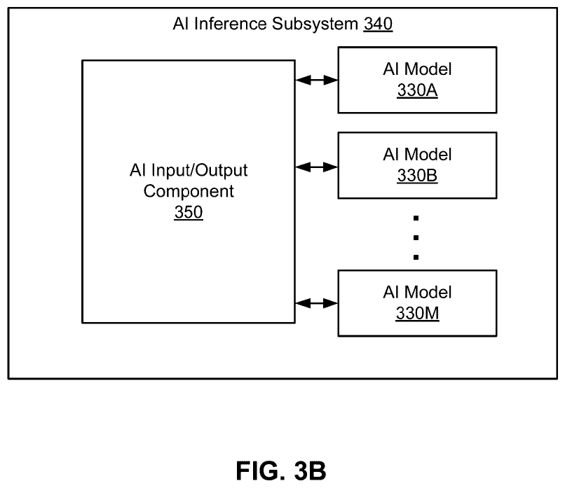

In some implementations, generating the summary of the virtual meeting 122 includes using a generative AI model to generate the summary of the virtual meeting 122. The generative AI model may be part of the AI inference subsystem of the absent user manager 138. The generative AI model may include a large language model (LLM) or another type of generative AI model as discussed below in relation to FIGS. 3A and 3B. Using the generative AI model to generate the summary of the virtual meeting 122 may include inputting a generative AI prompt into the generative AI model. The generative AI prompt can be based, at least in part, on the first data and a transcript of the virtual meeting. As an example, the first data may include textual content that includes “Points for discussion: (1) last week's progress on Project A; (2) upcoming deadlines for Project B; (3) guidelines for new employees.” The generative AI prompt may include “Generate a summary of the discussion of the following topics for the virtual meeting (1) last week's progress on Project A; (2) upcoming deadlines for Project B; (3) guidelines for new employees.” The generative AI prompt may further include the transcript of the virtual meeting 122.

In one implementation, the summary includes a text summary. The text summary can include one or more strings of text. The summary may include data in another format (e.g., an audio summary that includes audio data summarizing the virtual meeting 122). In one implementation, the summary includes video content. The video content may include a recording of the virtual meeting UI 108A-N and the associated audio data during a portion of the virtual meeting 122. The portion of the virtual meeting 122 may include the presentation of at least a portion of the first data during the virtual meeting 122.

In some implementations, the summary of the virtual meeting 122 includes one or more summaries of other portions of the virtual meeting 122 besides the presentation of the at least a portion of the first data. The summary of the virtual meeting 122 may include a summary of the entire virtual meeting 122. The one or more summaries of the virtual meeting 122 may include one or more summaries of one or more portions of the virtual meeting 122. In one implementation, a generative AI model generates the one or more summaries. The generative AI model may periodically generate a summary of a portion of the virtual meeting 122. The generative AI model may use the transcript of the virtual meeting 122 as input. For example, the generative AI model may generate a summary every 10 minutes, and the summary may summarize the transcript of the virtual meeting 122 that corresponds to the previous 10 minutes. In some implementations, a generative AI model generates a summary responsive to a user input received from a client device 102A-N, 104 of a participant of the virtual meeting 122 (e.g., a user input requesting the summary).

Generating a summary of the virtual meeting 122 can occur during the virtual meeting 122. Generating a summary of the virtual meeting 122 can occur after the conclusion of the virtual meeting 122.

At block 240, processing logic causes the summary to be accessible by a client device 102A-N, 104 of the first user associated with the virtual meeting 122. In some implementations, the absent user manager 138 stores the summary on the server 130, the data store 140, a cloud storage, a content management platform, or some other location. Causing the summary to be accessible by the client device 102A-N, 104 of the first user may include providing a reference to the summary stored on the server 130, in the data store 140, in the cloud storage, on the content management platform, etc. The summary being accessible by the client device 102A-N, 104 of the first user may include the absent user manager 138 providing a reference to the summary (e.g., a URL associated with the stored summary) to the first user's client device 102A-N, 104. In one implementation, the absent user manager 138 provides the summary to the client device 102A-N, 104 (e.g., by providing a file containing the summary to the client device 102A-N, 104 over the network 150).

In some implementations, causing the summary to be accessible by the client device 102A-N, 104 of the first user includes causing the summary to be accessible from a calendar invite. The calendar invite may include the calendar invite associated with the virtual meeting 122, as discussed above in relation to block 210. For example, the software calendar application may display, on a UI of the calendar software application, a calendar showing a block of time corresponding to the virtual meeting 122. Responsive to the first user interacting with the block of time on the UI, the UI may display an option for the client device 102A-N, 104 to access the summary.

In some implementations, causing the summary to be accessible by the client device 102A-N, 104 of the first user includes causing the summary to be accessible from an email sent to the first user. For example, the absent user manager 138 can provide the summary to an email application. The email application can execute on the server 130 or on another computing device. In one implementation, the absent user manager 138 causes the email application to generate an email that includes the summary in the body of the email. In some implementations, the absent user manager 138 causes the email application to generate an email that includes a reference to the summary stored on the server 130, in the data store 140, in the cloud storage, on the content management platform, etc. The absent user manager 138 can cause the email application to send the email to an email address of the first user.

In one implementation, processing logic records at least a portion of a presentation of the virtual meeting UI 108A-N and the first audio data of the one or more participants. The processing logic can cause the recorded presentation and the first audio data to be accessible by the client device 102A-N, 104 of the first user. The absent user manager 138 may store the recorded presentation and audio data on the server 130, the data store 140, or some other location. The absent user manager 138 may cause the presentation and audio data to be accessible, similar to the absent user manager 138 causing the summary of the virtual meeting 122 to be accessible to the first user's client device 102A-N, 104, as discussed above.

FIG. 3A illustrates an example AI training subsystem 300 that can be used to train one or more AI models 330A-M, in accordance with implementations of the present disclosure. As illustrated in FIG. 3A, the AI training subsystem 300 can include a training subsystem 310, which may include a training data engine 312, a training engine 314, a validation engine 316, a selection engine 318, or a testing engine 320. The AI training subsystem 300 may include one or more AI models 330A-M.

In one implementation, an AI model 330A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron may be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 330A-M includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), an LLM, or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, an AI model 330A-M is an AI model that has been trained on a corpus of data. For example, the AI model 330A-M can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 330A-M to learn broad elements including, image or speech recognition, general sentence structure, common phrases, vocabulary, natural language structure, and other elements. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 330A-M while training may be ranked by a user, according to a variety of factors, including accuracy, helpfulness, veracity, acceptability, or any other metric useful in the fine-tuning portion of training. In this manner, the AI model 330A-M can learn to favor these and any other factors relevant to users when generating a response. Further details regarding training are provided below.

In some implementations, an AI model 330A-M includes one or more pre-trained models, or fine-tuned models. In a non-limiting example, in some implementations, the goal of the “fine-tuning” can be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one implementation, the training subsystem 310 manages the training and testing of an AI model 330A-M. The training data engine 312 can generate training data. For example, in the present disclosure the training data may include textual content. The textual content may include one or more meeting transcripts (e.g., one or more virtual meeting transcripts)). The textual content can include other types of text data, such as text documents on various subjects. The training engine 314 may use the textual content training data to train a generative AI model configured to generate one or more summaries of a virtual meeting 122.

In some implementations, the training data can include audio data. The audio data may include data that includes a recording of a person speaking. The audio data may include one or more phonemes, word fragments, words, sentences, or other portions of speech. Each piece of audio training data may include a corresponding target out that includes a text representation of the audio data of the audio training data. The training data engine 312 may use the audio training data to train a speech-to-text AI model configured to generate a transcript of a virtual meeting 122.

In an illustrative example, the training data engine 312 can initialize a training set T to null (e.g., { }). The training data engine 312 can add the training data to the training set T and can determine whether training set T is sufficient for training a AI model 330A-M. The training set T can be sufficient for training the AI model 330A-M if the training set T includes a threshold amount of training data, in some implementations. In response to determining that the training set T is not sufficient for training, the training data engine 312 can identify additional data to use as training data. In response to determining that the training set T is sufficient for training, the training data engine 312 can provide the training set T to the training engine 314.

The training engine 314 can train an AI model 330A-M using the training data (e.g., training set T). The AI model 330A-M may refer to the model artifact that is created by the training engine 314 using the training data, where such training data can include training inputs and, in some implementations, corresponding target outputs. The training engine 314 can input the training data into the AI model 330A-M so that the AI model 330A-M can find patterns in the training data and configure itself based on those patterns.

Where the AI model 330A-M uses supervised learning, the training engine 314 can assist the AI model 330A-M in determining whether the AI model 330A-M maps the training input to the target output. Where the AI model 330A-M uses unsupervised learning, the training engine 314 can input the training data into the AI model 330A-M The AI model 330A-M can configure itself based on the input training data, but since the training data may not include a target output, the training engine 314 may not assist the AI model 330A-M in determining whether the AI model 330A-M provided a correct output during the training process.

The validation engine 316 may be capable of validating a trained AI model 330A-M using a corresponding set of features of a validation set from the training data engine 312. The validation engine 316 can determine an accuracy of each of the trained AI models 330A-M based on the corresponding sets of features of the validation set. Where the training data may not include a target output, validating a trained AI model 330A-M may include obtaining an output from the AI model 330A-M and providing the output to another entity for evaluation. The other entity may include another AI model configured to evaluation the output of the AI model 330A-M that is undergoing training. The other entity may include a human. The validation engine 316 can discard a trained AI model 330A-M that has an accuracy that does not meet a threshold accuracy or that otherwise fails evaluation. In some implementations, the selection engine 318 is capable of selecting a trained AI model 330A-M that has an accuracy that meets a threshold accuracy. In some implementations, the selection engine 318 may be capable of selecting the trained AI model 330A-M that has the highest accuracy of multiple trained AI models 330A-M. In some implementations, the selection engine 318 receives input from another AI model or a human and can select a trained AI model 330A-M based on the input.

The testing engine 320 may be capable of testing a trained AI model 330A-M using a corresponding set of features of a testing set from the training data engine 312. For example, a first trained AI model 330A that was trained using a first set of features of the training set may be tested using the first set of features of the testing set. The testing engine 320 can determine a trained AI model 330A-M that has the highest accuracy or other evaluation of all of the trained AI models 330A-M based on the testing sets.

In one implementation, the training engine 314 trains an AI model 330A. The AI model 330A may include an AI model that generates a summary of a virtual meeting 122. The training data engine 312 can generate training data that includes one or more virtual meeting transcripts, and the training engine 314 can cause the AI model 330A to undergo an AI model training process using the training data. The AI model 330A can undergo a validation and testing process using the validation engine 316 and testing engine 320.

In some implementations, the AI training subsystem 300 is part of the server 130, the virtual meeting manager 132, or the absent user manager 138. Alternatively, the AI training subsystem 300 may be part of another server, system, sub-system, or it may be an independent system. In some implementations, the AI training subsystem 300 provides the trained one or more AI models 330A-M to the absent user manager 138.

FIG. 3B illustrates an example AI inference subsystem 340 that the absent user manager 138 may use to perform one or more operations, in accordance with implementations of the present disclosure. The AI inference subsystem 340 may include one or more AI models 330A-M. The one or more AI models 330A-M may include one or more of the AI models 330A-M trained by the AI training subsystem 300.

In some implementations, the AI inference subsystem includes an AI input/output component 350. The AI input/output component 350 can be configured to feed data as input to an AI model 330A-M, e.g., a transcript of the virtual meeting 122 from the absent user manager 138. The AI input/output component 350 can be configured to obtain one or more outputs from the one or more AI models 330A-M and provide the one or more outputs to the absent user manager 138.

As indicated above, in some embodiments, an AI model 330A-M includes an LLM. In some embodiments, the LLM includes generative AI functionality. The AI model 330A-M can generate new content based on provided input data (e.g., a transcript of the virtual meeting 122). The generative AI model 330A-M can be supported by a prompt subsystem (not shown), which may reside on the system architecture 100. The prompt subsystem can enable a user or a component of the system architecture 100 to access the generative AI model 330A-M. The prompt subsystem can be configured to perform automated identification of, and facilitate retrieval of, relevant and timely contextual information for efficient and accurate processing of prompts by the AI model 330A-M. Using the network 150 (or another network), the prompt subsystem may be in communication with one or more of the virtual meeting manager 132 or the absent user manager 138. Communications between the prompt subsystem and the AI input/output component 350 can be facilitated by a generative model application programming interface (API), in some embodiments. Communications between the prompt subsystem and the virtual meeting manager 132 or the absent user manager 138 can be facilitated by a data management API. In additional or alternative embodiments, the generative model API translates prompts generated by the prompt subsystem into an unstructured natural-language format and, conversely, translates responses received from the AI model 330A-M into any suitable form (e.g., including any structured proprietary format as may be used by the prompt subsystem). Similarly, the data management API can support instructions that may be used to communicate data requests to the virtual meeting manager 132 or the absent user manager 138 and formats of data received from such components.

The prompt subsystem may include (or may have access to) instructions stored on one or more tangible, machine-readable storage media of a computing device (e.g., the server 130) and executable by one or more processing devices of the computing device. In one embodiment, the prompt subsystem can be implemented on a single machine. In some embodiments, the prompt subsystem may be a combination of a client component and a server component. Alternatively, some portion of the prompt subsystem may be executed on a client computing device while another portion of the query tool may be executed on a server machine.

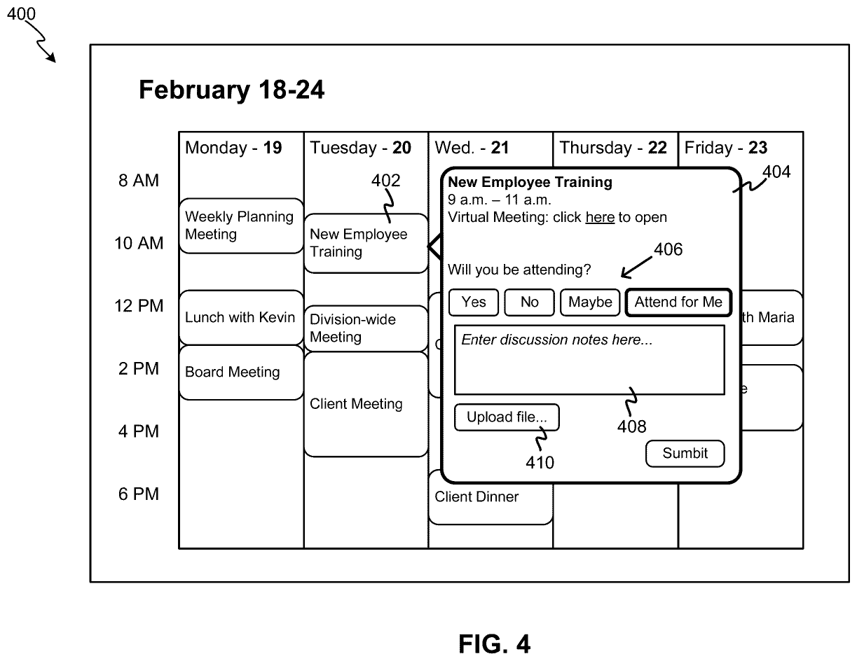

FIG. 4 depicts an example UI 400 of a calendar software application, in accordance with some implementations of the present disclosure. The UI 400 may be displayed on a display 107A-N of a client device 102A-N, 104. The UI 400 may include UI elements corresponding to one or more days of a week and one or more times during the day. For example, as seen in FIG. 4, the UI 400 includes five column UI elements corresponding to the days Monday, Tuesday, Wednesday, Thursday, and Friday of a week. As can also be seen in FIG. 4, the UI 400 can include times of the day along a left side of the UI 400. Where a day column and a time intersect, the UI 400 may include a UI element corresponding to a calendar event scheduled for that day and time. For example, as seen in FIG. 4, the UI 400 includes calendar event 402 scheduled for Tuesday from 9 a.m. to 11 a.m. and entitled “New Employee Training.”

In some implementations, responsive to a user interacting with the calendar event 402 UI element (e.g., by clicking on the UI element with a mouse or tapping the UI element on a touch screen), the UI 400 displays a detailed view 404 UI element corresponding to the calendar event 402. The detailed view 404 UI element can display further information associated with the calendar event 402. For example, as seen in FIG. 4, the detailed view 404 includes the title of the calendar event 402, the date and time of the calendar event 402, and a location of the calendar event. The location may include a virtual meeting 122. The user may access the virtual meeting 122 by interacting with a certain portion of the detailed view 404 (e.g., a URL included in the detailed view 404).

In one or more implementations, the detailed view 404 includes one or more UI elements that allow a user to indicate whether the user plans on attending the calendar event 402. For example, as seen in FIG. 4, the detailed view 404 includes buttons 406 labeled “Yes” to indicate that the user plans on attending, “No” to indicate that the user does not plan on attending, and “Maybe” to indicate that the user may attend. The buttons 406 can include an “Attend for Me” button to indicate that the user does not plan on attending the calendar event 402, but the user will provide the first data of block 210 of the method 200. Responsive to the user interacting with the “Attend for Me” button, as seen in FIG. 4, the UI 400 can display one or more UI elements where the user can provide the first data. For example, the UI can display a text box 408 where the user can input textual content or where the user can input a reference (e.g., a URL) to video content, audio content, or other types of content. The UI 400 can display a button 410 that opens a file selector that allows the user to select an audio file, video file, or another type of file. Responsive to the user finishing inputting the first data (e.g., by interacting with a “Submit” button, as seen in FIG. 4), the client device 102A-N, 104 operating the UI 400 may provide the first data to the absent user manager 138.

In some implementations, the user that is absent from the virtual meeting 122 may modify the first data after the absent user manager 138 obtains the first data. For example, the user may interact with the detailed view 404 again and use the text box 408 or file selector button 410 to input different first data, modify the originally provided first data, or remove at least a portion of the originally provided first data.

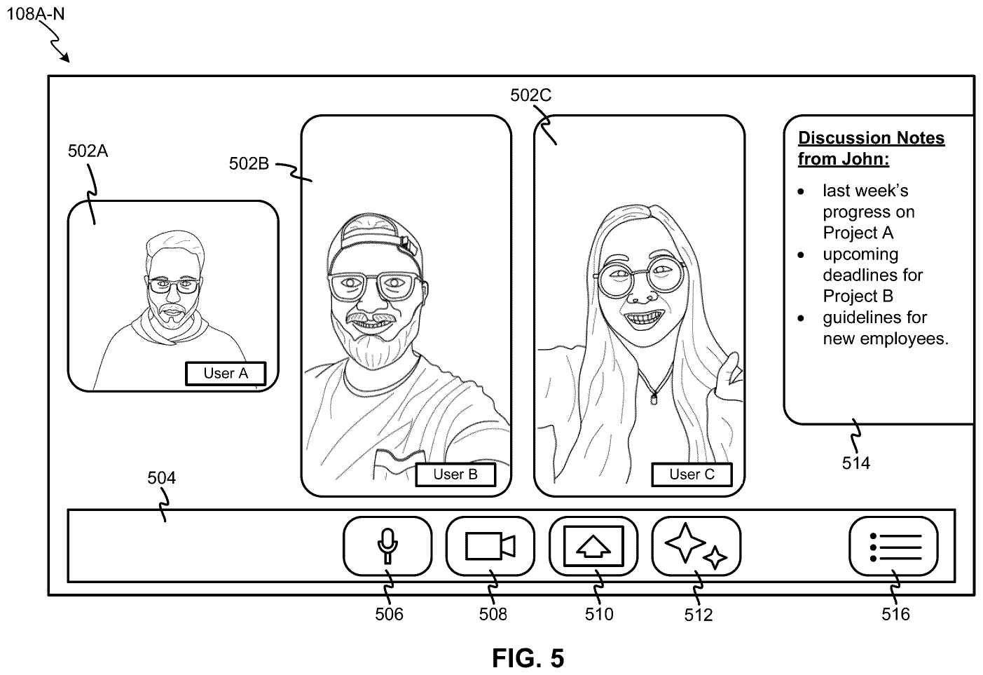

FIG. 5 depicts an example virtual meeting UI 108A-N, in accordance with some implementations of the present disclosure. The virtual meeting UI 108A-N may include one or more regions 502A-C corresponding to a visual item of the virtual meeting 122, such as a video stream provided by a client device 102A-N, 104 of a participant of the virtual meeting 122. The virtual meeting UI 108A-N can include a tool bar 504 that includes one or more UI elements configured to perform virtual meeting operations. For example, as seen in FIG. 5, the tool bar 504 includes an audio control button 506 used to mute and unmute a participant's audio stream, a camera control button 508 used to mute and unmute a participant's video stream, and a screen share button 510 used to share a participant's client device's 102A-N, 104 screen with other participants of the virtual meeting 122. In some implementations, the tool bar 504 may include one or more buttons 512 that, responsive to a participant interacting with the buttons 512, cause an AI model 330A-M to perform one or more virtual meeting 122 functions (e.g., generate a summary of at least a portion of the virtual meeting 122, generate action items, or other virtual meeting functionality discussed herein).

In one implementation, the virtual meeting UI 108A-N includes a side bar 514 UI element. The side bar 514 UI element can display information based on the first data provided by the user absent from the virtual meeting 122. For example, as seen in FIG. 5, the side bar 514 includes text data that includes discussion points provided by the absent user. As discussed above, the side bar 514 may include a reference to textual content, video content, audio content, or other types of content. The side bar 514 may include a media player within the side bar 514 used to play audio content or video content of the first data. In some implementations, the tool bar 504 includes a button that causes the UI 108A-N to display or hide the side bar 514.

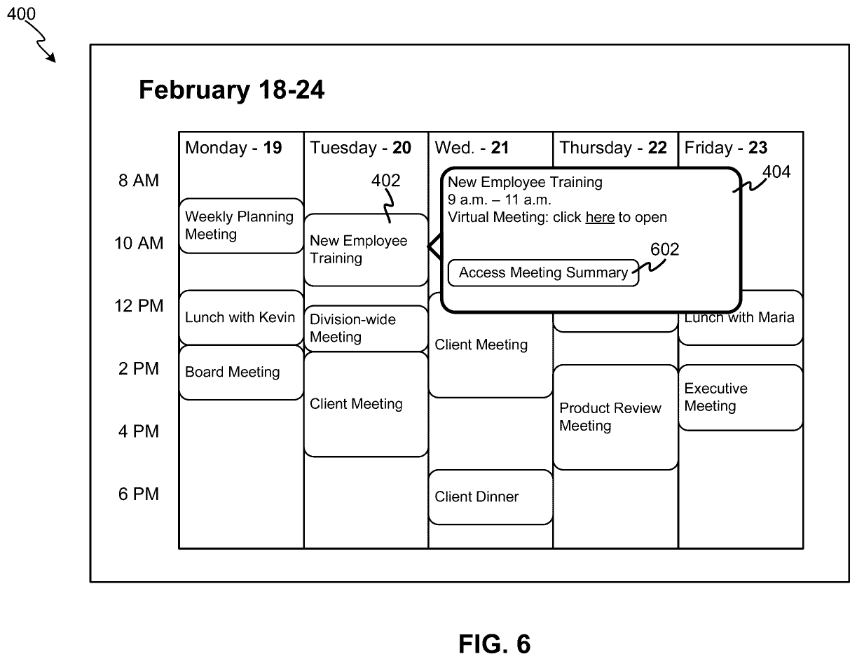

FIG. 6 depicts another example UI 400, in accordance with some implementations of the present disclosure. The UI 400 may include one or more components of the UI 400 discussed above in relation to FIG. 4, including one or more columns corresponding to days of a week, one or more times, one or more calendar events (e.g., the calendar event 402), and the detailed view 404 corresponding to the calendar event 402.

In some implementations, the UI 400 of FIG. 6 includes the UI 400 after the calendar event 402 has occurred. As can be seen in FIG. 6, the detailed view 404 corresponding to the calendar event 402 does not include the buttons 406 used to indicate whether the user can attend the calendar event 402. The detailed view 404 may include a UI element configured to provide access to a summary generated by the AI model 330A-M. For example, the UI element may include a button 602, and responsive to the user interacting with the button 602, the absent user manager 138 can cause the summary to be accessible by the client device 102A-N, 104 of the absent user, as discussed above. For example, responsive to the first user interacting with the button 602, the absent user manager 138 can provide a file to the client device 102A-N of the user over the network 150, and the file may include the summary in a text format. The absent user manager 138 can provide a reference (e.g., a URL) to data that includes the summary (e.g., a URL to a location in cloud storage). The detailed view 404 may include other UI elements that may allow the first user to access the transcript of the virtual meeting 122, a video recording of the virtual meeting 122, notes or action items of the virtual meeting 122, or other content associated with the virtual meeting 122.

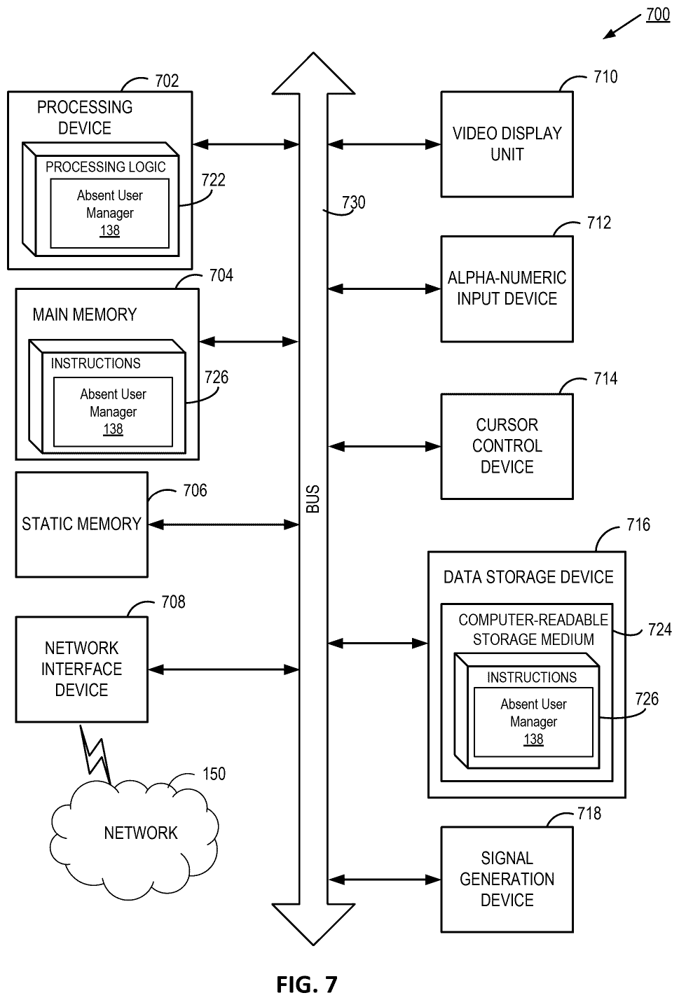

FIG. 7 is a block diagram illustrating an example computer system, in accordance with implementations of the present disclosure. The computer system 700 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 716, which communicate with each other via a bus 730.

The processing device 702 represents one or more general-purpose processing devices such as a microprocessor, central processing unit, or the like. More particularly, the processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute the processing logic 722 for performing the operations discussed herein (e.g., the operations of the absent user manager 138).

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (sometimes referred to as a “computer-readable storage medium”) on which is stored one or more sets of instructions 726 (e.g., the instructions to carry out one or more operations of the absent user manager 138) embodying any one or more of the methodologies or functions described herein. The instructions can also reside, completely or at least partially, within the main memory 704 and/or within the processing device 702 during execution thereof by the computer system 700, the main memory 704 and the processing device 702 also constituting machine-readable storage media. The instructions can further be transmitted or received over the network 150 via the network interface device 708.

In one implementation, the instructions 726 include instructions for determining visual items for presentation in a user interface of a virtual meeting. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method, comprising:
receiving input of a first user that has been invited to participate in a virtual meeting, wherein the input of the first user indicates an inability to attend the virtual meeting and provides first data to be discussed during the virtual meeting;
causing a virtual meeting user interface (UI) to be presented during the virtual meeting between a plurality of participants, the virtual meeting UI comprising a UI element associated with the first data provided by the first user that is not present during the virtual meeting;
generating a summary of the virtual meeting, wherein the summary covers presentation of at least a portion of the first data during the virtual meeting; and
causing the summary to be accessible by a client device of the first user associated with the virtual meeting.

2. The method of claim 1, wherein the input of the first user comprises a response to a calendar invite.

3. The method of claim 2, wherein causing the summary to be accessible by the client device of the first user comprises causing the summary to be accessible from at least one of:
the calendar invite; or
an email sent to the first user.

4. The method of claim 1, wherein the first data comprises at least one of:
textual content; or
audio content; or
video content.

5. The method of claim 1, further comprising causing presentation of the UI element associated with the first data responsive to a predetermined amount of time elapsing since a beginning of the virtual meeting.

6. The method of claim 1, wherein the UI element associated with the first data comprises at least one of:
a side bar disposed on a side of the virtual meeting UI; or
a notification presented in the virtual meeting UI.

7. The method of claim 1, wherein generating the summary of the virtual meeting comprises using a generative AI model to generate the summary of the virtual meeting.

8. The method of claim 7, wherein using the generative AI model to generate the summary of the virtual meeting comprises inputting a generative AI prompt into the generative AI model, wherein the generative AI prompt is based, at least in part, on the first data and a transcript of the virtual meeting.

9. A system, comprising:
a memory; and
a processing device, coupled to the memory, configured to perform operations, comprising:
receiving input of a first user that has been invited to participate in a virtual meeting, wherein the input of the first user indicates an inability to attend the virtual meeting and provides first data to be discussed during the virtual meeting;
causing a virtual meeting user interface (UI) to be presented during the virtual meeting between a plurality of participants, the virtual meeting UI comprising a UI element associated with the first data provided by the first user that is not present during the virtual meeting;
generating a summary of the virtual meeting, wherein the summary covers presentation of at least a portion of the first data during the virtual meeting; and
causing the summary to be accessible by a client device of the first user associated with the virtual meeting.

10. The system of claim 9, wherein:
the virtual meeting further comprises, for each participant of the plurality of participants, first audio data associated with an audio stream produced by a client device of a respective participant;
the operations further comprise:
recording at least a portion of a presentation of the virtual meeting UI and the first audio data of the plurality of participants; and
causing the recorded at least a portion of the presentation and the first audio data to be accessible by the client device of the first user.

11. The system of claim 9, wherein the input of the first user comprises a response to a calendar invite.

12. The system of claim 11, wherein causing the summary to be accessible by the client device of the first user comprises causing the summary to be accessible from at least one of:
the calendar invite; or
an email sent to the first user.

13. The system of claim 9, wherein the operations further comprise causing presentation of the UI element associated with the first data responsive to a predetermined amount of time elapsing since a beginning of the virtual meeting.

14. The system of claim 9, wherein the UI element associated with the first data comprises at least one of:
a side bar disposed on a side of the virtual meeting UI; or
a notification presented in the virtual meeting UI.

15. The system of claim 9, wherein generating the summary of the virtual meeting comprises using a generative AI model to generate the summary of the virtual meeting.

16. A non-transitory computer-readable storage medium comprising instructions that, when executed by a processing device, cause the processing device to perform operations, comprising:
receiving input of a first user that has been invited to participate in a virtual meeting, wherein the input of the first user indicates an inability to attend the virtual meeting and provides first data to be discussed during the virtual meeting;
causing a virtual meeting user interface (UI) to be presented during the virtual meeting between a plurality of participants, the virtual meeting UI comprising a UI element associated with the first data provided by the first user that is not present during the virtual meeting;
generating a summary of the virtual meeting, wherein the summary covers presentation of at least a portion of the first data during the virtual meeting; and
causing the summary to be accessible by a client device of the first user associated with the virtual meeting.

17. The computer-readable storage medium of claim 16, wherein causing the summary to be accessible by the client device of the first user comprises providing a reference to the summary stored in cloud storage.

18. The computer-readable storage medium of claim 16, wherein the first data comprises at least one of:
textual content; or
audio content; or
video content.

19. The computer-readable storage medium of claim 16, wherein the operations further comprise causing presentation of the UI element associated with the first data responsive to a predetermined amount of time elapsing since a beginning of the virtual meeting.

20. The computer-readable storage medium of claim 16, wherein the UI element associated with the first data comprises at least one of:
a side bar disposed on a side of the virtual meeting UI; or
a notification presented in the virtual meeting UI.
